(19) United States
(12) Patent Application Publication
(10) Pub. No.: US 2026/0155068 A1
(43) Pub. Date: Jun. 4, 2026

(54) GATE DRIVE CIRCUITRY AND DISPLAY PANEL

(71) Applicants: Huizhou China Star Optoelectronics Display Co., Ltd., Huizhou, Guangdong (CN); TCL China Star Optoelectronics Technology Co., Ltd., Shenzhen, Guangdong (CN)

(72) Inventor: Liu YANG, Huizhou (CN)

(21) Appl. No.: 18/547,185

(22) PCT Filed: Jul. 19, 2023
(86) PCT No.: PCT/CN2023/108102

§ 371 Date: Aug. 21, 2023

(30) Foreign Application Priority Data
Jun. 27, 2023 (CN) 202310773828.X

(51) Int. Cl. G09G 3/00

(52) U.S. Cl. CPC G09G 3/006; G09G 2300/0413; G09G 2310/0267; G09G 2320/045

(57) ABSTRACT

An Embodiment of the present application discloses a gate drive circuitry and a display panel, the gate drive circuitry includes a plurality of gate drive units and a plurality of dummy drive units, the gate drive units and the dummy drive units both includes a first pull-down maintaining module, and the first pull-down maintaining module includes a first transistor, where a length of a channel of the first transistor in the gate drive unit is lesser than a length of a channel of the first transistor in the dummy drive unit, and a width-to-length ratio of the channel of the first transistor in the gate drive unit is equal to a width-to-length ratio of the channel of the first transistor in the dummy drive unit.

### TECHNICAL FIELD

The present application relates to display technologies, and particularly, to a gate drive circuitry and a display panel.

### BACKGROUND

The existing high-resolution display panels are typically driven by a gate drive circuitry integrated on an array substrate (Gate-driver on Array, GOA). A dummy drive unit near an end of the gate drive circuitry is turned on by a start signal, the dummy drive unit is loaded with the start signal for a long time, which causes a threshold voltage of a corresponding pull-down transistor right-biased, and the decrease of the pull-down capability thereof. Therefore, the stage transmission signal output capability of the dummy drive unit near the end of the gate drive circuitry deteriorates, and a problem of dark lines occurs in a corresponding display area.

### TECHNICAL SOLUTION

The present application provides a gate drive circuitry and a display panel, which may improve the stage transmission signal output capability of a dummy drive unit near an end of the gate drive circuitry and improve the appearance of dark lines in a display area.

On the one hand, an embodiment of the present application provides a gate drive circuitry including a plurality of gate drive units; and a plurality of dummy drive units. The gate drive units are arranged in cascade with the dummy drive units, each of the gate drive units and the dummy drive units is configured to output a current-stage stage transmission signal, and each of the gate drive unit is further configured to output a current-stage scanning signal; each of the gate drive units and the dummy drive units include a first pull-down maintaining module, the first pull-down maintaining module is electrically connected with a pull-up node, a first reference low level signal terminal and a current-stage stage transmission signal output terminal, and the first pull-down maintaining module is configured to control potentials of the pull-up node and the current-stage stage transmission signal output terminal; and the first pull-down maintaining module includes a first transistor, a gate electrode of the first transistor is electrically connected with the pull-up node, a first electrode of the first transistor is electrically connected with a first pull-down node, and a second electrode of the first transistor is electrically connected with the first reference low level signal terminal; a length of a channel of the first transistor in the gate drive unit is lesser than a length of a channel of the first transistor in the dummy drive unit, and a width-to-length ratio of the channel of the first transistor in the gate drive unit is equal to a width-to-length ratio of the channel of the first transistor in the dummy drive unit.

Alternatively, in some embodiments of the present application, each of the gate drive unit and the dummy drive unit further includes an output module, the output module is configured to output the current-stage stage transmission signal, and the output module of the gate drive unit is further configured to output the current-stage scanning signal; the output module includes a second transistor, a gate electrode of the second transistor is electrically connected with the pull-up node, a first electrode of the second transistor is electrically connected with a clock signal terminal, and a second electrode of the second transistor is electrically connected with a stage transmission signal terminal; and a length of a channel of the second transistor in the gate drive unit is lesser than a length of a channel of the second transistor in the dummy drive unit, and a width-to-length ratio of the channel of the second transistor in the gate drive unit is equal to a width-to-length ratio of the channel of the second transistor in the dummy drive unit.

Alternatively, in some embodiments of the present application, the output module further includes a third transistor and a bootstrap capacitor, a gate electrode of the third transistor is electrically connected with the pull-up node, a first electrode of the third transistor is electrically connected with the clock signal terminal, a second electrode of the third transistor is electrically connected with a current-stage scanning signal output terminal, one end of the bootstrap capacitor is electrically connected with the pull-up node, and the other end of the bootstrap capacitor is electrically connected with the current-stage scanning signal output terminal; and a length of a channel of the third transistor in the gate drive unit is greater than a length of a channel of the third transistor in the dummy drive unit, and a width-to-length ratio of the channel of the third transistor in the gate drive unit is equal to a width-to-length ratio of the channel of the third transistor in the dummy drive unit.

Alternatively, in some embodiments of the present application, the first pull-down maintaining module further includes a fourth transistor, a fifth transistor and a sixth transistor, a gate electrode of the fourth transistor and a first electrode of the fourth transistor are electrically connected with a first control signal terminal, a second electrode of the fourth transistor is electrically connected with the first pull-down node, a gate electrode of the fifth transistor is electrically connected with the first pull-down node, a first electrode of the fifth transistor is electrically connected with the first control signal terminal, a second electrode of the fifth transistor is electrically connected with a second pull-down node, a gate electrode of the sixth transistor is electrically connected with the pull-up node, a first electrode of the sixth transistor is electrically connected with the second pull-down node, and a second electrode of the sixth transistor is electrically connected with the first reference low level signal terminal; a length of a channel of each of at least one of the fourth transistor, the fifth transistor, or the sixth transistor in the gate drive unit is lesser than a length of a channel of a corresponding one of the fourth transistor, the fifth transistor, and the sixth transistor in the dummy drive unit; and a width-to-length ratio of the channel of each of the fourth transistor, the fifth transistor and the sixth transistor in the gate drive unit is equal to a width-to-length ratio of the channel of each of the fourth transistor, the fifth transistor and the sixth transistor in the dummy drive unit.

Alternatively, in some embodiments of the present application, the first pull-down maintaining module further includes a seventh transistor, an eighth transistor and a ninth transistor, a gate electrode of the seventh transistor is electrically connected with the second pull-down node, a first electrode of the seventh transistor is electrically connected with a current-stage scanning signal output terminal, a second electrode of the seventh transistor is electrically connected with a second reference low level signal terminal, a gate electrode of the eighth transistor is electrically connected with the second pull-down node, a first electrode of the eighth transistor is electrically connected with the pull-up node, a second electrode of the eighth transistor is electrically connected with the first reference low level signal terminal, a gate electrode of the ninth transistor is electrically connected with the second pull-down node, a first electrode of the ninth transistor is electrically connected with the current-stage stage transmission signal output terminal, and a second electrode of the ninth transistor is electrically connected with the first reference low level signal terminal; and a length of a channel of each of the seventh transistor and the eighth transistor in the gate drive unit is greater than a length of a channel of a corresponding one of the seventh transistor and the eighth transistor in the dummy drive unit, and a width-to-length ratio of the channel of each of the seventh transistor and the eighth transistor in the gate drive unit is equal to a width-to-length ratio of the channel of each of the seventh transistor and the eighth transistor in the dummy drive unit.

Alternatively, in some embodiments of the present application, a length of a channel of the ninth transistor in the gate drive unit is greater than or equal to a length of a channel of the ninth transistor in the dummy drive unit, and a width-to-length ratio of the channel of the ninth transistor in the gate drive unit is equal to a width-to-length ratio of the channel of the ninth transistor in the dummy drive unit.

Alternatively, in some embodiments of the present application, each of the gate drive unit and the dummy drive unit further includes a second pull-down maintaining module, the second pull-down maintaining module is electrically connected with the pull-up node, the first reference low level signal terminal, and the current-stage stage transmission signal output terminal, and the second pull-down maintaining module is configured to control potentials of the pull-up node and the current-stage stage transmission signal output terminal; the second pull-down maintaining module includes a tenth transistor, a gate electrode of the tenth transistor is electrically connected with the pull-up node, a first electrode of the tenth transistor is electrically connected with a third pull-down node, and a second electrode of the tenth transistor is electrically connected with the first reference low level signal terminal; and a length of a channel of the tenth transistor in the gate drive unit is lesser than a length of a channel of the tenth transistor in the dummy drive unit, and a width-to-length ratio of the channel of the tenth transistor in the gate drive unit is equal to a width-to-length ratio of the channel of the tenth transistor in the dummy drive unit.

Alternatively, in some embodiments of the present application, the second pull-down maintaining module further includes an eleventh transistor, a twelfth transistor and a thirteenth transistor, a gate electrode of the eleventh transistor and a first electrode of the eleventh transistor are electrically connected with a second control signal terminal, a second electrode of the eleventh transistor is electrically connected with the third pull-down node, a gate electrode of the twelfth transistor is electrically connected with the third pull-down node, a first electrode of the twelfth transistor is electrically connected with the second control signal terminal, a second electrode of the twelfth transistor is electrically connected with a fourth pull-down node, a gate electrode of the thirteenth transistor is electrically connected with the pull-up node, a first electrode of the thirteenth transistor is electrically connected with the fourth pull-down node, and a second electrode of the thirteenth transistor is electrically connected with the first reference low level signal terminal; a length of a channel of each of at least one of the eleventh transistor, the twelfth transistor, or the thirteenth transistor in the gate drive unit is lesser than a length of a channel of a corresponding one of the eleventh transistor, the twelfth transistor, and the thirteenth transistor in the dummy drive unit; and a width-to-length ratio of the channel of each of the eleventh transistor, the twelfth transistor and the thirteenth transistor in the gate drive unit is equal to a width-to-length ratio of the channel of a corresponding one of the eleventh transistor, the twelfth transistor and the thirteenth transistor in the dummy drive unit.

Alternatively, in some embodiments of the present application, the second pull-down maintaining module further includes a fourteenth transistor, a fifteenth transistor and a sixteenth transistor, a gate electrode of the fourteenth transistor is electrically connected with the fourth pull-down node, a first electrode of the fourteenth transistor is electrically connected with a current-stage scanning signal output terminal, a second electrode of the fourteenth transistor is electrically connected with a second reference low level signal terminal, a gate electrode of the fifteenth transistor is electrically connected with the fourth pull-down node, a first electrode of the fifteenth transistor is electrically connected with the pull-up node, a second electrode of the fifteenth transistor is electrically connected with the first reference low level signal terminal, a gate electrode of the sixteenth transistor is electrically connected with the fourth pull-down node, a first electrode of the sixteenth transistor is electrically connected with the current-stage stage transmission signal output terminal, and a second electrode of the sixteenth transistor is electrically connected with the first reference low level signal terminal; and a length of a channel of each of the fourteenth transistor and the fifteenth transistor in the gate drive unit is greater than a length of a channel of a corresponding one of the fourteenth transistor and the fifteenth transistor in the dummy drive unit, and a width-to-length ratio of the channel of each of the fourteenth transistor and the fifteenth transistor in the gate drive unit is equal to a width-to-length ratio of the channel of a corresponding one of the fourteenth transistor and the fifteenth transistor in the dummy drive unit.

Alternatively, in some embodiments of the present application, a length of a channel of the sixteenth transistor in the gate drive unit is greater than or equal to a length of a channel of the sixteenth transistor in the dummy drive unit, and a width-to-length ratio of the channel of the sixteenth transistor in the gate drive unit is equal to a width-to-length ratio of the channel of the sixteenth transistor in the dummy drive unit.

On the other hand, the present application further provides a display panel, the display panel including a display area and a non-display area disposed around the display area, where the non-display area is provided with a gate drive circuitry, the gate drive circuitry includes a plurality of gate drive units; and a plurality of dummy drive units. The gate drive units are arranged in cascade with the dummy drive units, each of the gate drive units and the dummy drive units is configured to output a current-stage stage transmission signal, and each of the gate drive unit is further configured to output a current-stage scanning signal; each of the gate drive units and the dummy drive units include a first pull-down maintaining module, the first pull-down maintaining module is electrically connected with a pull-up node, a first reference low level signal terminal and a current-stage stage transmission signal output terminal, and the first pull-down maintaining module is configured to control potentials of the pull-up node and the current-stage stage transmission signal output terminal; and the first pull-down maintaining module includes a first transistor, a gate electrode of the first transistor is electrically connected with the pull-up node, a first electrode of the first transistor is electrically connected with a first pull-down node, and a second electrode of the first transistor is electrically connected with the first reference low level signal terminal; a length of a channel of the first transistor in the gate drive unit is lesser than a length of a channel of the first transistor in the dummy drive unit, and a width-to-length ratio of the channel of the first transistor in the gate drive unit is equal to a width-to-length ratio of the channel of the first transistor in the dummy drive unit.

Alternatively, in some embodiments of the present application, each of the gate drive unit and the dummy drive unit further includes an output module, the output module is configured to output the current-stage stage transmission signal, and the output module of the gate drive unit is further configured to output the current-stage scanning signal; the output module includes a second transistor, a gate electrode of the second transistor is electrically connected with the pull-up node, a first electrode of the second transistor is electrically connected with a clock signal terminal, and a second electrode of the second transistor is electrically connected with a stage transmission signal terminal; and a length of a channel of the second transistor in the gate drive unit is lesser than a length of a channel of the second transistor in the dummy drive unit, and a width-to-length ratio of the channel of the second transistor in the gate drive unit is equal to a width-to-length ratio of the channel of the second transistor in the dummy drive unit.

Alternatively, in some embodiments of the present application, the output module further includes a third transistor and a bootstrap capacitor, a gate electrode of the third transistor is electrically connected with the pull-up node, a first electrode of the third transistor is electrically connected with the clock signal terminal, a second electrode of the third transistor is electrically connected with a current-stage scanning signal output terminal, one end of the bootstrap capacitor is electrically connected with the pull-up node, and the other end of the bootstrap capacitor is electrically connected with the current-stage scanning signal output terminal; and a length of a channel of the third transistor in the gate drive unit is greater than a length of a channel of the third transistor in the dummy drive unit, and a width-to-length ratio of the channel of the third transistor in the gate drive unit is equal to a width-to-length ratio of the channel of the third transistor in the dummy drive unit.

Alternatively, in some embodiments of the present application, the first pull-down maintaining module further includes a fourth transistor, a fifth transistor and a sixth transistor, a gate electrode of the fourth transistor and a first electrode of the fourth transistor are electrically connected with a first control signal terminal, a second electrode of the fourth transistor is electrically connected with the first pull-down node, a gate electrode of the fifth transistor is electrically connected with the first pull-down node, a first electrode of the fifth transistor is electrically connected with the first control signal terminal, a second electrode of the fifth transistor is electrically connected with a second pull-down node, a gate electrode of the sixth transistor is electrically connected with the pull-up node, a first electrode of the sixth transistor is electrically connected with the second pull-down node, and a second electrode of the sixth transistor is electrically connected with the first reference low level signal terminal; a length of a channel of each of at least one of the fourth transistor, the fifth transistor, or the sixth transistor in the gate drive unit is lesser than a length of a channel of a corresponding one of the fourth transistor, the fifth transistor, and the sixth transistor in the dummy drive unit; and a width-to-length ratio of the channel of each of the fourth transistor, the fifth transistor and the sixth transistor in the gate drive unit is equal to a width-to-length ratio of the channel of each of the fourth transistor, the fifth transistor and the sixth transistor in the dummy drive unit.

Alternatively, in some embodiments of the present application, the first pull-down maintaining module further includes a seventh transistor, an eighth transistor and a ninth transistor, a gate electrode of the seventh transistor is electrically connected with the second pull-down node, a first electrode of the seventh transistor is electrically connected with a current-stage scanning signal output terminal, a second electrode of the seventh transistor is electrically connected with a second reference low level signal terminal, a gate electrode of the eighth transistor is electrically connected with the second pull-down node, a first electrode of the eighth transistor is electrically connected with the pull-up node, a second electrode of the eighth transistor is electrically connected with the first reference low level signal terminal, a gate electrode of the ninth transistor is electrically connected with the second pull-down node, a first electrode of the ninth transistor is electrically connected with the current-stage stage transmission signal output terminal, and a second electrode of the ninth transistor is electrically connected with the first reference low level signal terminal; and a length of a channel of each of the seventh transistor and the eighth transistor in the gate drive unit is greater than a length of a channel of a corresponding one of the seventh transistor and the eighth transistor in the dummy drive unit, and a width-to-length ratio of the channel of each of the seventh transistor and the eighth transistor in the gate drive unit is equal to a width-to-length ratio of the channel of each of the seventh transistor and the eighth transistor in the dummy drive unit.

Alternatively, in some embodiments of the present application, a length of a channel of the ninth transistor in the gate drive unit is greater than or equal to a length of a channel of the ninth transistor in the dummy drive unit, and a width-to-length ratio of the channel of the ninth transistor in the gate drive unit is equal to a width-to-length ratio of the channel of the ninth transistor in the dummy drive unit.

Alternatively, in some embodiments of the present application, each of the gate drive unit and the dummy drive unit further includes a second pull-down maintaining module, the second pull-down maintaining module is electrically connected with the pull-up node, the first reference low level signal terminal, and the current-stage stage transmission signal output terminal, and the second pull-down maintaining module is configured to control potentials of the pull-up node and the current-stage stage transmission signal output terminal; the second pull-down maintaining module includes a tenth transistor, a gate electrode of the tenth transistor is electrically connected with the pull-up node, a first electrode of the tenth transistor is electrically connected with a third pull-down node, and a second electrode of the tenth transistor is electrically connected with the first reference low level signal terminal; and a length of a channel of the tenth transistor in the gate drive unit is lesser than a length of a channel of the tenth transistor in the dummy drive unit, and a width-to-length ratio of the channel of the tenth transistor in the gate drive unit is equal to a width-to-length ratio of the channel of the tenth transistor in the dummy drive unit.

Alternatively, in some embodiments of the present application, the second pull-down maintaining module further includes an eleventh transistor, a twelfth transistor and a thirteenth transistor, a gate electrode of the eleventh transistor and a first electrode of the eleventh transistor are electrically connected with a second control signal terminal, a second electrode of the eleventh transistor is electrically connected with the third pull-down node, a gate electrode of the twelfth transistor is electrically connected with the third pull-down node, a first electrode of the twelfth transistor is electrically connected with the second control signal terminal, a second electrode of the twelfth transistor is electrically connected with a fourth pull-down node, a gate electrode of the thirteenth transistor is electrically connected with the pull-up node, a first electrode of the thirteenth transistor is electrically connected with the fourth pull-down node, and a second electrode of the thirteenth transistor is electrically connected with the first reference low level signal terminal; a length of a channel of each of at least one of the eleventh transistor, the twelfth transistor, or the thirteenth transistor in the gate drive unit is lesser than a length of a channel of a corresponding one of the eleventh transistor, the twelfth transistor, and the thirteenth transistor in the dummy drive unit; and a width-to-length ratio of the channel of each of the eleventh transistor, the twelfth transistor and the thirteenth transistor in the gate drive unit is equal to a width-to-length ratio of the channel of a corresponding one of the eleventh transistor, the twelfth transistor and the thirteenth transistor in the dummy drive unit.

Alternatively, in some embodiments of the present application, the second pull-down maintaining module further includes a fourteenth transistor, a fifteenth transistor and a sixteenth transistor, a gate electrode of the fourteenth transistor is electrically connected with the fourth pull-down node, a first electrode of the fourteenth transistor is electrically connected with a current-stage scanning signal output terminal, a second electrode of the fourteenth transistor is electrically connected with a second reference low level signal terminal, a gate electrode of the fifteenth transistor is electrically connected with the fourth pull-down node, a first electrode of the fifteenth transistor is electrically connected with the pull-up node, a second electrode of the fifteenth transistor is electrically connected with the first reference low level signal terminal, a gate electrode of the sixteenth transistor is electrically connected with the fourth pull-down node, a first electrode of the sixteenth transistor is electrically connected with the current-stage stage transmission signal output terminal, and a second electrode of the sixteenth transistor is electrically connected with the first reference low level signal terminal; and a length of a channel of each of the fourteenth transistor and the fifteenth transistor in the gate drive unit is greater than a length of a channel of a corresponding one of the fourteenth transistor and the fifteenth transistor in the dummy drive unit, and a width-to-length ratio of the channel of each of the fourteenth transistor and the fifteenth transistor in the gate drive unit is equal to a width-to-length ratio of the channel of a corresponding one of the fourteenth transistor and the fifteenth transistor in the dummy drive unit.

Alternatively, in some embodiments of the present application, a length of a channel of the sixteenth transistor in the gate drive unit is greater than or equal to a length of a channel of the sixteenth transistor in the dummy drive unit, and a width-to-length ratio of the channel of the sixteenth transistor in the gate drive unit is equal to a width-to-length ratio of the channel of the sixteenth transistor in the dummy drive unit.

### BENEFICIAL EFFECT

In the gate drive circuitry provided in the embodiments of the present application, the length of the channel of the first transistor in the gate drive unit is lesser than the length of the channel of the first transistor in the dummy drive unit, and the width-to-length ratio of the channel of the first transistor in the gate drive unit is equal to the width-to-length ratio of the channel of the first transistor in the dummy drive unit, that is, the length of the channel of the first transistor in the dummy drive unit is increased, and the channel width of the first transistor in the dummy drive unit is correspondingly adjusted, so that the width-to-length ratio of the channel of the first transistor in the dummy drive unit is kept unchanged, thereby improving the stage transmission signal output capability of the dummy drive unit near an end of the gate drive circuitry, and solving the problem of dark lines occurring in the display area.

### BRIEF DESCRIPTION OF THE DRAWINGS

FIG. 1 is a schematic block diagram of a gate drive circuitry according to an embodiment of the present application.

FIG. 2a is a schematic diagram showing a gate drive unit in the gate drive circuitry in FIG. 1 according to an embodiment of the present application.

FIG. 2b is a comparison diagram of a first transistor to be adjusted and an adjusted first transistor in the dummy drive unit in FIG. 1.

FIG. 3a is a waveform of a current-stage scanning signal output by the gate drive unit when the dummy drive unit is not adjusted; and FIG. 3b is a waveform of the current-stage scanning signal output by the gate drive unit after the dummy drive unit is adjusted.

FIG. 4a is a waveform of a current-stage stage transmission signal output from the dummy drive unit after the dummy drive unit is adjusted.

FIG. 4b is a waveform of the current-stage scanning signal output by the gate drive unit after the dummy drive unit is adjusted.

FIG. 5 is a schematic diagram of a gate drive unit in the gate drive circuitry in FIG. 1 according to an embodiment of the present application.

FIG. 6 is a schematic diagram of a gate drive unit in the gate drive circuitry in FIG. 1 according to an embodiment of the present application.

FIG. 7 is a schematic diagram of a gate drive unit in the gate drive circuitry in FIG. 1 according to an embodiment of the present application.

FIG. 8 is a schematic diagram of a gate drive unit in the gate drive circuitry in FIG. 1 according to an embodiment of the present application.

FIG. 9 is a schematic diagram of a gate drive unit in the gate drive circuitry in FIG. 1 according to an embodiment of the present application.

### DETAILED DESCRIPTION

The technical solutions in embodiments of the present application will be described below with reference to the drawings in the embodiments of the present application. The described embodiments are merely to explain and illustrate the concept of the present application and should not be construed as limiting the protection scope of the present application.

Transistors employed in all embodiments of the present application may be thin film transistors or other devices having similar characteristics. In the embodiments of the present application, in order to distinguish two electrodes of the transistor except a gate electrode, one of source and drain electrodes is referred to as a first electrode, and the other of the source and drain electrodes is referred to as a second electrode. According to forms specified in the drawings, a signal control terminal of a switching transistor is a gate electrode, a signal input terminal is a first electrode, and a signal output terminal is a second electrode. In addition, the transistor used in the embodiments of the present invention is an N-type transistor or a P-type transistor, where the N-type transistor is turned on when the gate electrode is at a high potential and turned off when the gate electrode is at a low potential; and the P-type transistor is turned on when the gate electrode is at a low potential and turned off when the gate electrode is a high potential.

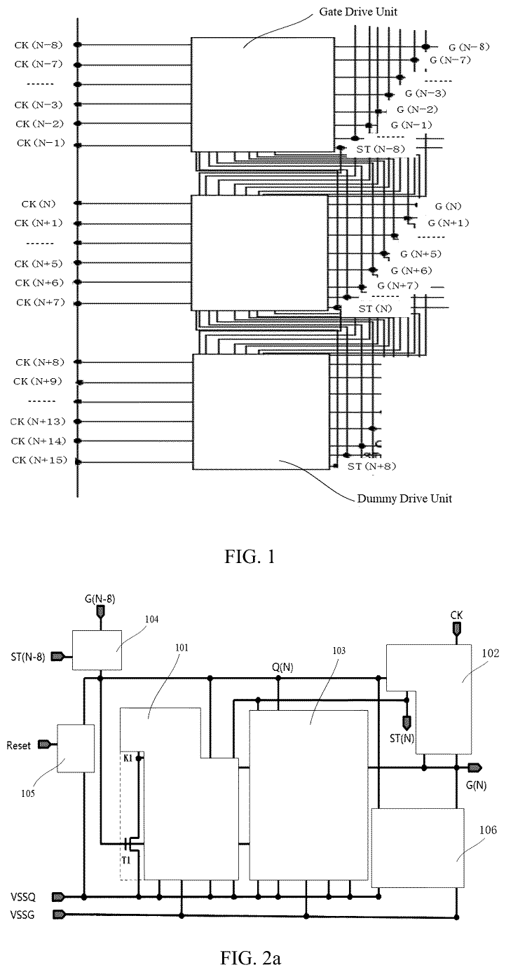

As shown in FIG. 1, a gate drive circuitry provided in an embodiment of the present application includes a plurality of gate drive units Normal and a plurality of dummy drive units Dummy, the gate drive units Normal are provided in cascade with the dummy drive units Dummy, the gate drive units Normal and the dummy drive units Dummy are both used for outputting a current-stage stage transmission signal ST(N−1, N, N+1, . . . ), and the gate drive units Normal are further used for outputting a current-stage scanning signal G(N−1, N, N+1, . . . ). FIG. 1 takes a (N−1)th-stage gate drive unit Normal, a Nth-stage gate drive unit Normal and a (N+1)th-stage gate drive unit Normal which are cascaded as an example.

When the Nth-stage gate drive unit Normal is operated, a scanning signal output by the Nth-stage gate drive unit Normal is at a high potential for turning on a transistor switch of each pixel in a row in a display panel and charging a pixel electrode in each pixel through a data signal; and the Nth-stage stage transmission signal is used to control the operation of the (N+1)th-stage gate drive unit Normal. When the (N+1)th-stage gate drive unit Normal is operated, a scanning signal output by the (N+1)th-stage gate drive unit Normal is at a high potential, at the same time, the scanning signal output by the Nth-stage gate drive unit Normal is at a low potential.

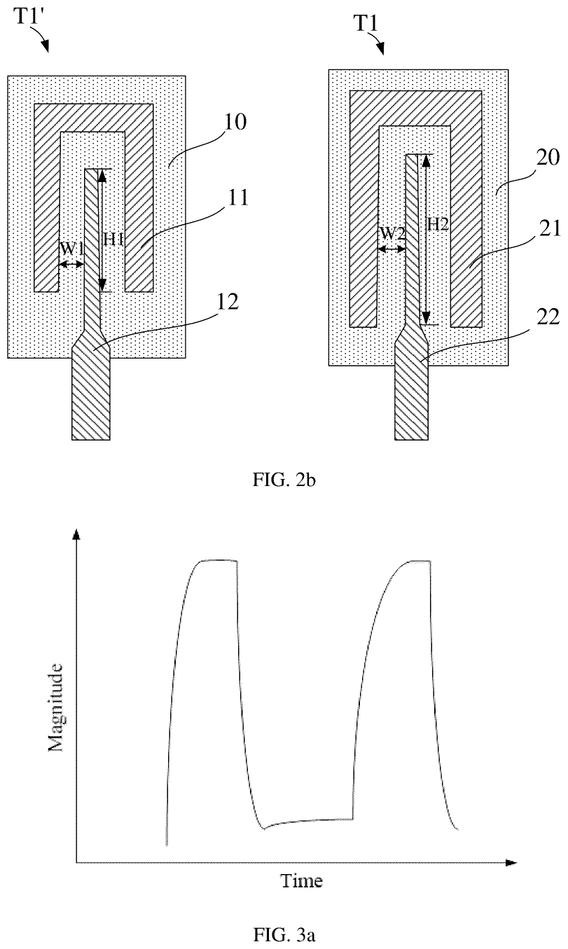

As shown in FIG. 2a, the gate drive unit and the dummy drive unit both include a first pull-down maintaining module 101, the first pull-down maintaining module 101 is electrically connected with a pull-up node Q, a first reference low level signal terminal VSSQ and a current-stage stage transmission signal output terminal ST(N−1, N, N+1 . . . ), which is indicated by a same reference symbol as the current-stage stage transmission signal, and is used to control potentials of the pull-up node Q and the current-stage stage transmission signal output terminal ST(N−1, N, N+1 . . . ). The first pull-down maintaining module 101 includes a first transistor T1, a gate electrode of the first transistor T1 is electrically connected with the pull-up node Q, a first electrode of the first transistor T1 is electrically connected with a first pull-down node K1, and a second electrode of the first transistor T1 is electrically connected with the first reference low level signal terminal VSSQ. Where a length of a channel of the first transistor T1 in the gate drive unit is lesser than a length of a channel of the first transistor T1 in the dummy drive unit, and a width-to-length ratio of the channel of the first transistor T1 in the gate drive unit is equal to a width-to-length ratio of the channel of the first transistor T1 in the dummy drive unit. Specifically, the first pull-down maintaining module 101 is also electrically connected with a second reference low level signal terminal VSSG.

Experimental verification shows that after high-temperature and high-humidity aging of the gate drive circuitry provided in the present application, if the length of the channel of the first transistor T1 is reduced, horizontal dark lines appear in a corresponding display area. That is, the length of the channel of the first transistor T1 has a significant effect on the waveform output by the current-stage scanning signal G(N−1, N, N+1 . . . ) of the gate drive unit. Therefore, as shown in FIG. 2b, a first transistor T1′ to be adjusted includes a first active layer 10, a first source electrode 11, and a first drain electrode 12, and the adjusted first transistor T1 includes a second active layer 20, a second source electrode 21, and a second drain electrode 22. Where a length of a channel H2 of the adjusted first transistor T1 is greater than a length of a channel H1 of the first transistor T1′ to be adjusted, and a channel width W2 of the adjusted first transistor T1 is greater than a channel width W1 of the first transistor T1′ to be adjusted, so that a width-to-length ratio of the channel of the adjusted first transistor T1 is equal to a width-to-length ratio of the channel of the first transistor T1′ to be adjusted. That is, in the embodiment of the present application, by increasing the length of the channel of the first transistor T1 in the dummy drive unit and correspondingly adjusting the channel width so as to keep the width-to-length ratio of the channel of the first transistor T1 in the dummy drive unit unchanged, the stability of the first transistor T1 in the dummy drive unit can be improved, and a problem of occurring horizontal dark lines in the display area corresponding to an end of the gate drive circuitry (in particular, in a pixel unit electrically connected with a last-stage gate drive unit) is avoided, the problem is caused by the deterioration of the output capability of the current-stage stage transmission signal ST(N−1, N, N+1 . . . ) caused by the electric leakage of the first pull-down maintaining module 101 and the further caused deterioration of the pull-down capability of the pull-down transistor of the gate drive unit.

In the embodiment of the present application, both the gate drive unit and the dummy drive unit include an output module 102, and the output module 102 is electrically connected with a clock signal terminal CK, the pull-up node Q and a current-stage scanning signal output terminal G(N−1, N, N+1 . . . ), which is indicated by a same reference symbol as the current-stage scanning signal. The output module 102 is used to output the current-stage stage transmission signal ST(N−1, N, N+1 . . . ), and the output module 102 is also used to output the current-stage scanning signal G(N−1, N, N+1 . . . ). Specifically, the current-stage scanning signal output terminal G(N−1, N, N+1 . . . ) of the gate drive unit is electrically connected with a corresponding scan line.

In the embodiment of the present application, both the gate drive unit and the dummy drive unit include a second pull-down maintaining module 103, the second pull-down maintaining module 103 is electrically connected with the pull-up node Q, the first reference low level signal terminal VSSQ and the current-stage stage transmission signal output terminal ST(N−1, N, N+1 . . . ) , the second pull-down maintaining module 103 is used to control potentials of the pull-up node Q and current-stage stage transmission signal output terminal ST(N−1, N, N+1 . . . ), the second pull-down maintaining module 103 alternately operates with the first pull-down maintaining module 101 to increase the performance and lifetime of the device by sharing work load.

In the embodiment of the present application, both the gate drive unit and the dummy drive unit include a pull-up control module 104, a reset module 105 and a pull-down module 106, the pull-up control module 104 is electrically connected with a stage transmission scanning signal output terminal G(N−8) and a stage transmission signal output terminal ST(N−8) of an (N−8)th stage. The reset module 105 is electrically connected with a reset signal terminal Reset, the pull-up node Q and the first reference low level signal terminal VSSQ. The pull-down module 106 is electrically connected with the pull-up node Q, the current-stage scanning signal output terminal G(N−1, N, N+1 . . . ), the first reference low level signal terminal VSSQ and the second reference low level signal terminal VSSG. The pull-up control module 104 is used to control the potential of the pull-up node Q, and specifically, the pull-up control module 104 is used to pull up the potential of the pull-up node Q. The reset module 105 is used to reset the potential of the pull-up node Q. The pull-down module 106 is used to control the pull-up node Q and the current-stage scanning signal output terminal G(N−1, N, N+1 . . . ), specifically, the pull-down module 106 is used to pull down the potentials of the pull-up node Q and the current-stage scanning signal output terminal G(N−1, N, N+1 . . . ).

It should be noted that a circuit structure of the gate drive unit is the same as that of the dummy drive unit. the length of the channel of the first transistor in the dummy drive unit is adjusted, and the channel width of the first transistor is correspondingly adjusted according to the length of the channel after adjustment, so that the width-to-length ratio of the channel of the first transistor is kept unchanged.

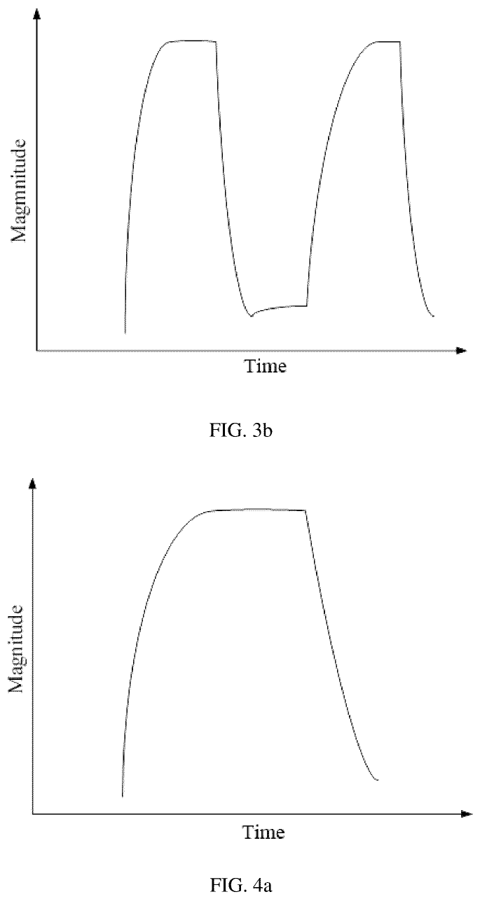

Although the adjustment of the length of the channel may affect the stability and performance of the circuit, as shown in FIGS. 3a and 3b, when the length of the channel of the first transistor T1 in the dummy drive unit is adjusted appropriately, the waveform of the current-stage scanning signal G(N−1, N, N+1 . . . ) output by the gate drive unit has no significant difference, that is, the adjustment of the length of the channel of the first transistor T1 in the dummy drive unit does not affect the waveform of the current-stage scanning signal G(N−1, N, N+1 . . . ) output by the gate drive unit.

It should be noted that test parameters before and after adjustment of the lengths of the channels of the first transistor T1 in the dummy drive unit do not change, including the temperature, a threshold voltage of the transistor and a reference high level, and specifically, the temperature in a low temperature environment is less than or equal to minus 40 degrees Celsius, preferably equal to minus 50 degrees Celsius. The temperature in a high temperature environment is greater than or equal to 200 degrees Celsius, preferably equal to 250 degrees Celsius. The threshold voltage of the P-type transistor is greater than or equal to 6 volts, and the threshold voltage of the N-type transistor is less than or equal to minus 5 volts. The reference high level is less than or equal to 12V.

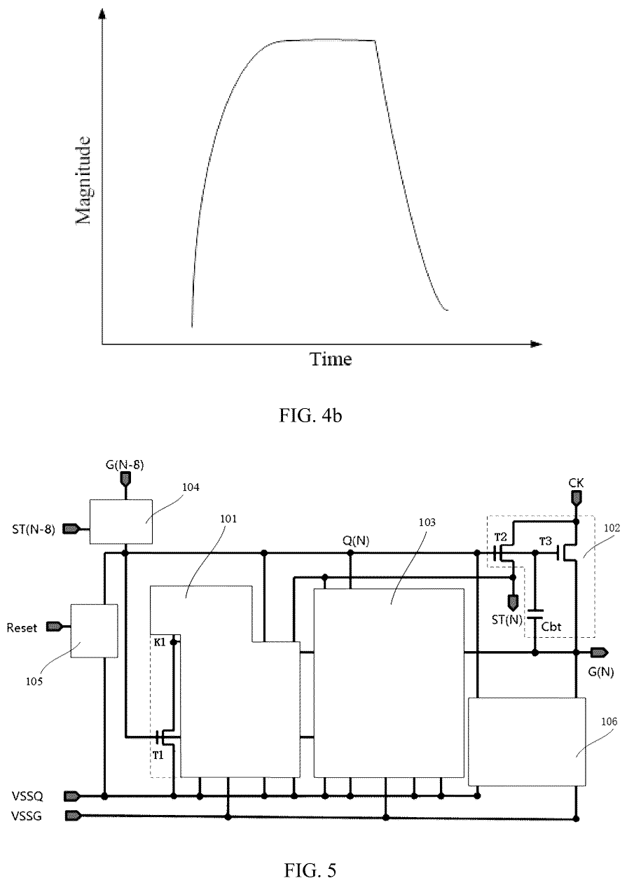

In addition, as shown in FIGS. 4a and 4b, after the length of the channel of the first transistor T1 in the dummy drive unit is adjusted, the waveform of the current-stage stage transmission signal ST(N−1, N, N+1 . . . ) output by the dummy drive unit has no significant difference from the waveform of the current-stage scanning signal G(N−1, N, N+1 . . . ) output by the gate drive unit, that is, after the length of the channel of the first transistor T1 in the dummy drive unit is adjusted, the waveform of the current-stage stage transmission signal ST(N−1, N, N+1 . . . ) output by the dummy drive unit can be kept within a range of the predetermined waveform specification, and such adjustment does not affect the waveform of the current-stage scanning signal G(N−1, N, N+1 . . . ) output by the gate drive unit.

In the gate drive circuitry provided in the embodiment of the present application, the length of the channel of the first transistor T1 in the gate drive unit is made lesser than the length of the channel of the first transistor T1 in the dummy drive unit, and the width-to-length ratio of the channel of the first transistor T1 in the gate drive unit is equal to the width-to-length ratio of the channel of the first transistor T1 in the dummy drive unit, that is, the length of the channel of the first transistor T1 in the dummy drive unit is increased, and the channel width of the first transistor T1 in the dummy drive unit is correspondingly adjusted, so that the width-to-length ratio of the channel of the first transistor T1 in the dummy drive unit is kept unchanged, thereby improving the signal output capability of the dummy drive unit, and benefiting solving the problem that dark lines occur in the display area.

As a specific embodiment of the present application, as shown in FIG. 5, the output module 102 includes a second transistor T2, a gate electrode of the second transistor T2 is electrically connected with the pull-up node Q, a first electrode of the second transistor T2 is electrically connected with the clock signal terminal CK, and a second electrode of the second transistor T2 is electrically connected with a current-stage stage transmission signal terminal ST(N−1, N, N+1 . . . ). A length of a channel of the second transistor T2 in the gate drive unit is lesser than a length of a channel of the second transistor T2 in the dummy drive unit, and a width-to-length ratio of the channel of the second transistor T2 in the gate drive unit is equal to a width-to-length ratio of the channel of the second transistor T2 in the dummy drive unit.

In the embodiment of the present application, the output module 102 further includes a third transistor T3 and a bootstrap capacitor, a gate electrode of the third transistor T3 is electrically connected with the pull-up node Q, a first electrode of the third transistor T3 is electrically connected with the clock signal terminal CK, and a second electrode of the third transistor T3 is electrically connected with the current-stage scanning signal output terminal G(N−1, N, N+1 . . . ), one end of the bootstrap capacitor is electrically connected with the pull-up node Q, and the other end of the bootstrap capacitor is electrically connected with the current-stage scanning signal output terminal G(N−1, N, N+1 . . . ). A length of a channel of the third transistor T3 in the gate drive unit is greater than a length of a channel of the third transistor T3 in the dummy drive unit, and a width-to-length ratio of the channel of the third transistor T3 in the gate drive unit is equal to a width-to-length ratio of the channel of the third transistor T3 in the dummy drive unit.

In the gate drive circuitry provided in the embodiment of the present application, the length of the channel of the second transistor T2 in the dummy drive unit is further increased, and at the same time, the width-to-length ratio of the channel of the second transistor T2 in the dummy drive unit is kept unchanged. At the same time, the channel of the third transistor T3 in the dummy drive unit is correspondingly reduced and the width-to-length ratio of the channel of the third transistor T3 in the dummy drive unit is kept unchanged, and size parameters of the second transistor T2 are adjusted and a size of the bootstrap capacitor is kept unchanged so as to further improve the output capacity of the current-stage stage transmission signal ST(N−1, N, N+1 . . . ), which is beneficial to effectively improve the problem of horizontal dark lines in a display area.

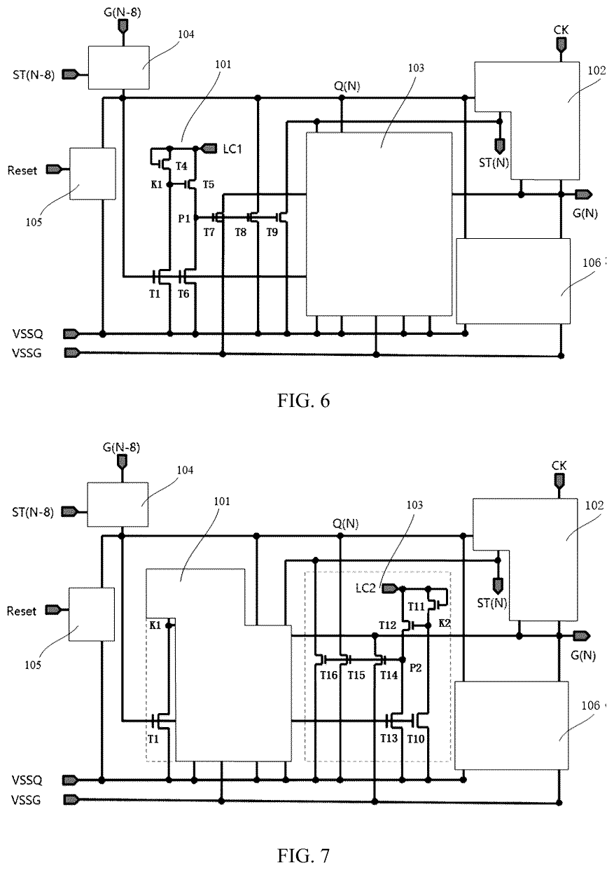

As a specific embodiment of the present application, as shown in FIG. 6, the first pull-down maintaining module 101 further includes a fourth transistor T4, a fifth transistor T5 and a sixth transistor T6, a gate electrode of the fourth transistor T4 and a first electrode of the fourth transistor T4 are electrically connected with a first control signal terminal, a second electrode of the fourth transistor T4 is electrically connected with a first pull-down node K1, a gate electrode of the fifth transistor T5 is electrically connected with the first pull-down node K1, a first electrode of the fifth transistor T5 is electrically connected with the first control signal terminal, the second electrode of the fifth transistor T5 is electrically connected with a second pull-down node P1, a gate electrode of the sixth transistor T6 is electrically connected with a pull-up node Q, a first electrode of the sixth transistor T6 is electrically connected with the second pull-down node P1, and a second electrode of the sixth transistor T6 is electrically connected with a first reference low level signal terminal VSSQ. A length of a channel of the fourth transistor T4 in the gate drive unit is lesser than a length of a channel of the fourth transistor T4 in the dummy drive unit, and/or, a length of a channel of the fifth transistor T5 in the gate drive unit is lesser than a length of a channel of the fifth transistor T5 in the dummy drive unit, and/or, a length of a channel of the sixth transistor T6 in the gate drive unit is lesser than a length of a channel of the sixth transistor T6 in the dummy drive unit. And width-to-length ratios of the channels of the fourth transistor T4, the fifth transistor T5 and the sixth transistor T6 in the gate drive unit are equal to width-to-length ratios of the channels of the fourth transistor T4, the fifth transistor T5 and the sixth transistor T6 in the dummy drive unit, respectively.

Specifically, the lengths of the channels of the fourth transistor T4, the fifth transistor T5 and the sixth transistor T6 in the dummy drive unit may be increased appropriately at the same time, or only the length of the channel of at least one of the fourth transistor T4, the fifth transistor T5, or the sixth transistor T6 may be increased appropriately, and the width-to-length ratios of the channels of the fourth transistor T4, the fifth transistor T5 and the sixth transistor T6 are kept unchanged, thereby improving the performance of the transistors and further improving the capacity of the dummy drive unit outputting the current-stage stage transmission signal ST(N−1, N, N+1 . . . ), and improving the problem of the dark lines in the display area.

In the embodiment of the present application, the first pull-down maintaining module 101 further includes a seventh transistor T7, an eighth transistor T8 and a ninth transistor T9, a gate electrode of the seventh transistor T7 is electrically connected with the second pull-down node P1, and a first electrode of the seventh transistor T7 is electrically connected with the current-stage scanning signal output terminal G(N−1, N, N+1 . . . ), a second electrode of the seventh transistor T7 is electrically connected with the second reference low level signal terminal VSSG, a gate electrode of the eighth transistor T8 is electrically connected with the second pull-down node P1, a first electrode of the eighth transistor T8 is electrically connected with the pull-up node Q, a second electrode of the eighth transistor T8 is electrically connected with the first reference low level signal terminal VSSQ, a gate electrode of the ninth transistor T9 is electrically connected with the second pull-down node P1, and a first electrode of the ninth transistor T9 is electrically connected with the current-stage stage transmission signal output terminal ST(N−1, N, N+1 . . . ), a second electrode of the ninth transistor T9 is electrically connected with the first reference low level signal terminal VSSQ. Lengths of channels of the seventh transistor T7 and the eighth transistor T8 in the gate drive unit are both greater than lengths of channels of the seventh transistor T7 and the eighth transistor T8 in the dummy drive unit, and width-to-length ratios of the channels of the seventh transistor T7 and the eighth transistor T8 in the gate drive unit are equal to width-to-length ratios of the channels of the seventh transistor T7 and the eighth transistor T8 in the dummy drive unit.

In the gate drive circuitry provided in the embodiment of the present application, the reason for causing the horizontal dark lines is that the threshold voltages of the first transistor T1 and the fourth transistor T4 deviate to the right under the action of long-term stress, the potentials of the first pull-down node K1 and the second pull-down node P1 are not pulled down to the potential of a first reference low level in time, the potential of the second pull-down node P1 is too high, which causes the electric leakage of the seventh transistor T7, the eighth transistor T8 and the ninth transistor T9 and further causes the deterioration of the capacity outputting the current-stage stage transmission signal ST(N−1, N, N+1 . . . ), therefore, in the present application, the lengths of the channels of the first transistor T1, the fourth transistor T4, the fifth transistor T5 and the sixth transistor T6 in the dummy drive unit are appropriately increased, and the width-to-length ratios of the channels thereof are kept unchanged, so that the performance thereof is improved, the potentials of the first pull-down node K1 and the second pull-down node P1 are ensured to be pulled down in time, the deterioration of the capacity outputting the current-stage stage transmission signal ST(N−1, N, N+1 . . . ) caused by the electric leakage is avoided, and the problem of the horizontal dark line is improved. Further, the lengths of the channels of the seventh transistor T7 and the eighth transistor T8 in the dummy drive unit are appropriately reduced to ensure the layout space of the first transistor T1, the fourth transistor T4, the fifth transistor T5 and the sixth transistor T6 in the dummy drive unit.

In the embodiment of the present application, a length of a channel of the ninth transistor T9 in the gate drive unit is greater than or equal to a length of a channel of the ninth transistor T9 in the dummy drive unit, and a width-to-length ratio of the channel of the ninth transistor T9 in the gate drive unit is equal to a width-to-length ratio of the channel of the ninth transistor T9 in the dummy drive unit. That is, the length of the channel of the ninth transistor T9 in the dummy drive unit may be reduced or kept unchanged, and a person skilled in the art can adjust the length of the channel according to actual requirements, and it is not specifically limited here in the present application.

As a specific embodiment of the present application, as shown in FIG. 7, a second pull-down maintaining module 103 includes a tenth transistor T10, a gate electrode of the tenth transistor T10 is electrically connected with the pull-up node Q, a first electrode of the tenth transistor T10 is electrically connected with the third pull-down node K2, and a second electrode of the tenth transistor T10 is electrically connected with the first reference low level signal terminal VSSQ. A length of a channel of the tenth transistor T10 in the gate drive unit is lesser than a length of a channel of the tenth transistor T10 in the dummy drive unit, and a width-to-length ratio of the channel of the tenth transistor T10 in the gate drive unit is equal to a width-to-length ratio of the channel of the tenth transistor T10 in the dummy drive unit.

In the embodiment of the present application, the second pull-down maintaining module 103 further includes an eleventh transistor T11, a twelfth transistor T12 and a thirteenth transistor T13, a gate electrode of the eleventh transistor T11 and a first electrode of the eleventh transistor T11 are electrically connected with a second control signal terminal, a second electrode of the eleventh transistor T11 is electrically connected with the third pull-down node K2, a gate electrode of the twelfth transistor T12 is electrically connected with the third pull-down node K2, a first electrode of the twelfth transistor T12 is electrically connected with the second control signal terminal, a second electrode of the twelfth transistor T12 is electrically connected with a fourth pull-down node P2, a gate electrode of the thirteenth transistor T13 is electrically connected with the pull-up node Q, a first electrode of the thirteenth transistor T13 is electrically connected with the fourth pull-down node P2, and a second electrode of the thirteenth transistor T13 is electrically connected with the first reference low level signal terminal VSSQ. A length of a channel of the eleventh transistor T11 in the gate drive unit is lesser than a length of a channel of the eleventh transistor T11 in the dummy drive unit, and/or, a length of a channel of the twelfth transistor T12 in the gate drive unit is lesser than a length of a channel of the twelfth transistor T12 in the dummy drive unit, and/or, a length of a channel of the thirteenth transistor T13 in the gate drive unit is lesser than a length of a channel of the thirteenth transistor T13 in the dummy drive unit. And width-to-length ratios of the channels of the eleventh transistor T11, the twelfth transistor T12 and the thirteenth transistor T13 in the gate drive unit are equal to width-to-length ratios of the channels of the eleventh transistor T11, the twelfth transistor T12 and the thirteenth transistor T13 in the dummy drive unit, respectively.

In the embodiment of the present application, the second pull-down maintaining module 103 further includes a fourteenth transistor T14, a fifteenth transistor T15 and a sixteenth transistor T16, a gate electrode of the fourteenth transistor T14 is electrically connected with the fourth pull-down node P2, and a first electrode of the fourteenth transistor T14 is electrically connected with the current-stage scanning signal output terminal G(N−1, N, N+1 . . . ), a second electrode of the fourteenth transistor T14 is electrically connected with the second reference low level signal terminal VSSG, a gate electrode of the fifteenth transistor T15 is electrically connected with the fourth pull-down node P2, a first electrode of the fifteenth transistor T15 is electrically connected with the pull-up node Q, a second electrode of the fifteenth transistor T15 is electrically connected with the first reference low level signal terminal VSSQ, a gate electrode of the sixteenth transistor T16 is electrically connected with the fourth pull-down node P2, a first electrode of the sixteenth transistor T16 is electrically connected with the current-stage stage transmission signal output terminal ST(N−1, N, N+1 . . . ), and a second electrode of the sixteenth transistor T16 is electrically connected with the first reference low level signal terminal VSSQ. Lengths of channels of the fourteenth transistor T14 and the fifteenth transistor T15 in the gate drive unit are both greater than lengths of channels of the fourteenth transistor T14 and the fifteenth transistor T15 in the dummy drive unit, and width-to-length ratios of the channels of the fourteenth transistor T14 and the fifteenth transistor T15 in the gate drive unit are equal to width-to-length ratios of the channels of the fourteenth transistor T14 and the fifteenth transistor T15 in the dummy drive unit.

In the embodiment of the present application, a length of a channel of the sixteenth transistor T16 in the gate drive unit is greater than or equal to a length of a channel of the sixteenth transistor T16 in the dummy drive unit, and a width-to-length ratio of the channel of the sixteenth transistor T16 in the gate drive unit is equal to a width-to-length ratio of the channel of the sixteenth transistor T16 in the dummy drive unit.

In in the gate drive circuitry provided in the embodiment of the present application, the operation principle of the second pull-down maintaining module 103 of the dummy driving module is the same as that of the first pull-down maintaining module 101, and the second pull-down maintaining module 103 and the first pull-down maintaining module 101 alternately operate. Therefore, the channel adjustment principle of the corresponding transistor in the second pull-down maintaining module 103 will not be described.

As shown in FIG. 8, the pull-up control module 104 includes a seventeenth transistor T17, a gate electrode of the seventeenth transistor T17 is electrically connected with the stage transmission signal terminal of the (N−8)th stage, a first electrode of the seventeenth transistor T17 is electrically connected with the scanning signal output terminal G(N−1, N, N+1 . . . ) of the (N−8)th stage, a second electrode of the seventeenth transistor T17 is electrically connected with the pull-up node Q. The reset module 105 includes an eighteenth transistor T18, a gate electrode of the eighteenth transistor T18 is electrically connected with the reset signal terminal Reset, a first electrode of the eighteenth transistor T18 is electrically connected with the pull-up node Q, and a second electrode of the eighteenth transistor T18 is electrically connected with the first reference low level signal terminal VSSQ. The pull-down module 106 includes a nineteenth transistor T19 and a twentieth transistor T20, a gate electrode of the nineteenth transistor T19 is electrically connected with a stage transmission signal terminal corresponding to the lower eighth stage, a first electrode of the nineteenth transistor T19 is electrically connected with the pull-up node Q, and a second electrode of the nineteenth transistor T19 is electrically connected with the first reference low level signal terminal VSSQ. A gate electrode of the twentieth transistor T20 is electrically connected with the stage transmission signal terminal corresponding to the next eighth stage, and a first electrode of the twentieth transistor T20 is connected with a current-stage scanning signal output terminal G(N−1, N, N+1 . . . ), and a second electrode of the twentieth transistor T20 is electrically connected with the second reference low level signal terminal VSSG.

In the gate drive circuitry provided in the embodiment of the present application, a number of clock signals is preferably 16CK, that is, includes an 8-stage dummy drive units, as shown in FIG. 8, control terminals of the pull-down module 106 of the Nth-stage gate drive unit/dummy drive unit in the present application, that is, the gate electrodes of the nineteenth transistor T19 and the twentieth transistor T20, are connected to the stage transmission signal ST(N+8).

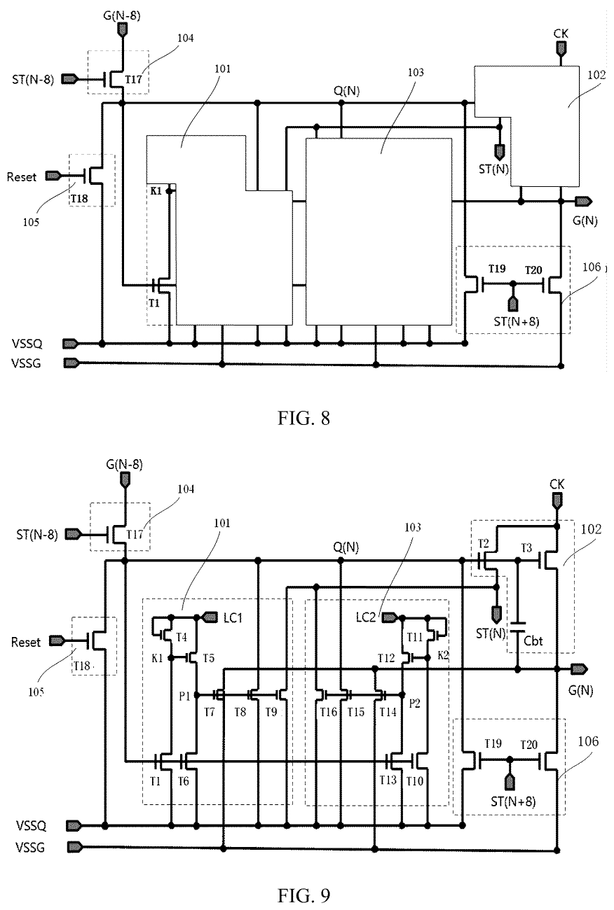

As a specific embodiment of the present application, as shown in FIG. 9, the gate drive unit includes a first pull-down maintaining module 101, an output module 102, a second pull-down maintaining module 103, a pull-up control module 104, a reset module 105, and a pull-down module 106.

The first pull-down maintaining module 101 includes a first transistor T1, a fourth transistor T4, a fifth transistor T5, a sixth transistor T6, a seventh transistor T7, an eighth transistor T8 and a ninth transistor T9, a gate electrode of the first transistor T1 is electrically connected with a pull-up node Q, a first electrode of the first transistor T1 is electrically connected with a first pull-down node K1, and a second electrode of the first transistor T1 is electrically connected with a first reference low level signal terminal VSSQ. A gate electrode of the fourth transistor T4 and a first electrode of the fourth transistor T4 are electrically connected with a first control signal terminal, a second electrode of the fourth transistor T4 is electrically connected with the first pull-down node K1, a gate electrode of the fifth transistor T5 is electrically connected with the first pull-down node K1, a first electrode of the fifth transistor T5 is electrically connected with the first control signal terminal, a second electrode of the fifth transistor T5 is electrically connected with a second pull-down node P1, a gate electrode of the sixth transistor T6 is electrically connected with the pull-up node Q, a first electrode of the sixth transistor T6 is electrically connected with the second pull-down node P1, and a second electrode of the sixth transistor T6 is electrically connected with the first reference low signal terminal VSSQ. A gate electrode of the seventh transistor T7 is electrically connected with the second pull-down node P1, and a first electrode of the seventh transistor T7 is electrically connected with the current-stage scanning signal output terminal G(N−1, N, N+1 . . . ), a second electrode of the seventh transistor T7 is electrically connected with a second reference low level signal terminal VSSG, a gate electrode of the eighth transistor T8 is electrically connected with the second pull-down node P1, a first electrode of the eighth transistor T8 is electrically connected with the pull-up node Q, a second electrode of the eighth transistor T8 is electrically connected with the first reference low level signal terminal VSSQ, a gate electrode of the ninth transistor T9 is electrically connected with the second pull-down node P1, and a first electrode of the ninth transistor T9 is electrically connected with the current-stage stage transmission signal output terminal ST(N−1, N, N+1 . . . ), a second electrode of the ninth transistor T9 is electrically connected with the first reference low level signal terminal VSSQ.

The output module 102 includes a second transistor T2, a third transistor T3 and a bootstrap capacitor, a gate electrode of the second transistor T2 is electrically connected with the pull-up node Q, a first electrode of the second transistor T2 is electrically connected with a clock signal terminal CK, and a second electrode of the second transistor T2 is electrically connected with a current-stage stage transmission signal terminal ST(N−1, N, N+1 . . . ). A gate electrode of the third transistor T3 is electrically connected with the pull-up node Q, a first electrode of the third transistor T3 is electrically connected with the clock signal terminal CK, and a second electrode of the third transistor T3 is electrically connected with the current-stage scanning signal output terminal G(N−1, N, N+1 . . . ), one end of the bootstrap capacitor is electrically connected with the pull-up node Q, and the other end of the bootstrap capacitor is electrically connected with the current-stage scanning signal output terminal G(N−1, N, N+1 . . . ).

The second pull-down maintaining module 103 includes a tenth transistor T10, an eleventh transistor T11, a twelfth transistor T12, a thirteenth transistor T13, a fourteenth transistor T14, a fifteenth transistor T15 and a sixteenth transistor T16, a gate electrode of the tenth transistor T10 is electrically connected with the pull-up node Q, a first electrode of the tenth transistor T10 is electrically connected with a third pull-down node K2, and a second electrode of the tenth transistor T10 is electrically connected with the first reference low level signal terminal VSSQ. A gate electrode of the eleventh transistor T11 and a first electrode of the eleventh transistor T11 are electrically connected with a second control signal terminal, a second electrode of the eleventh transistor T11 is electrically connected with the third pull-down node K2, a gate electrode of the twelfth transistor T12 is electrically connected with the third pull-down node K2, a first electrode of the twelfth transistor T12 is electrically connected with the second control signal terminal, a second electrode of the twelfth transistor T12 is electrically connected with a fourth pull-down node P2, a gate electrode of the thirteenth transistor T13 is electrically connected with the pull-up node Q, a first electrode of the thirteenth transistor T13 is electrically connected with the fourth pull-down node P2, and a second electrode of the thirteenth transistor T13 is electrically connected with the first reference low level signal terminal VSSQ. A gate electrode of the fourteenth transistor T14 is electrically connected with the fourth pull-down node P2, and a first electrode of the fourteenth transistor T14 and the current-stage scanning signal output terminal G(N−1, N, N+1 . . . ), a second electrode of the fourteenth transistor T14 is electrically connected with the second reference low level signal terminal VSSG, a gate electrode of the fifteenth transistor T15 is electrically connected with the fourth pull-down node P2, a first electrode of the fifteenth transistor T15 is electrically connected with the pull-up node Q, a second electrode of the fifteenth transistor T15 is electrically connected with the first reference low level signal terminal VSSQ, a gate electrode of the sixteenth transistor T16 is electrically connected with the fourth pull-down node P2, and a first electrode of the sixteenth transistor T16 is electrically connected with the current-stage stage transmission signal output terminal ST(N−1, N, N+1 . . . ) , and a second electrode of the sixteenth transistor T16 is electrically connected with the first reference low level signal terminal VSSQ.

The pull-up control module 104 includes a seventeenth transistor T17, a gate electrode of the seventeenth transistor T17 is electrically connected with a stage transmission signal of the (N−8)th stage, a first electrode of the seventeenth transistor T17 is electrically connected with a scanning signal output terminal G(N−8) of the (N−8)th stage, and a second electrode of the seventeenth transistor T17 is electrically connected with the pull-up node Q.

The reset module 105 includes an eighteenth transistor T18, a gate electrode of the eighteenth transistor T18 is electrically connected with a reset signal terminal Reset, a first electrode of the eighteenth transistor T18 is electrically connected with the pull-up node Q, and a second electrode of the eighteenth transistor T18 is electrically connected with the first reference low level signal terminal VSSQ.

The pull-down module 106 includes a nineteenth transistor T19 and a twentieth transistor T20, a gate electrode of the nineteenth transistor T19 is electrically connected with a stage transmission signal terminal corresponding to the lower eighth stage, a first electrode of the nineteenth transistor T19 is electrically connected with the pull-up node Q, and a second electrode of the nineteenth transistor T19 is electrically connected with the first reference low level signal terminal VSSQ. A gate electrode of the twentieth transistor T20 is electrically connected with the stage transmission signal terminal corresponding to the lower eighth stage, a first electrode of the twentieth transistor T20 is electrically connected with a current-stage scanning signal output terminal G(N+8), and a second electrode of the twentieth transistor T20 is electrically connected with the second reference low level signal terminal VSSG.

lengths of channels of the first transistor T1, the second transistor T2, the fourth transistor T4, the fifth transistor T5, the sixth transistor T6, the tenth transistor T10, the eleventh transistor T11, the twelfth transistor T12 and the thirteenth transistor T13 in the gate drive unit are all lesser than lengths of channels of the first transistor T1, the second transistor T2, the fourth transistor T4, the fifth transistor T5, the sixth transistor T6, the tenth transistor T10, the eleventh transistor T11, the twelfth transistor T12 and the thirteenth transistor T13 in the dummy drive unit, and width-to-length ratios of the channels of the first transistor T1, the second transistor T2, the fourth transistor T4, the fifth transistor T5, the sixth transistor T6, the tenth transistor T10, the eleventh transistor T11, the twelfth transistor T12 the thirteenth transistor T13 in the gate drive unit are equal to width-to-length ratios of the channels of the first transistor T1, the second transistor T2, the fourth transistor T4, the fifth transistor T5, the sixth transistor T6, the tenth transistor T10, the eleventh transistor T11, the twelfth transistor T12 and the thirteenth transistor T13 in the dummy drive unit.

Lengths of channels of the third transistor T3, the seventh transistor T7, the eighth transistor T8, the fourteenth transistor T14 and the fifteenth transistor T15 in the gate drive unit are all greater than lengths of channels of the third transistor T3, the seventh transistor T7, the eighth transistor T8, the fourteenth transistor T14 and the fifteenth transistor T15 in the dummy drive unit, and width-to-length ratios of the channels of the third transistor T3, the seventh transistor T7, the eighth transistor T8, the fourteenth transistor T14 and the fifteenth transistor T15 in the gate drive unit are equal to width-to-length ratios of the channels of the third transistor T3, the seventh transistor T7, the eighth transistor T8, the fourteenth transistor T14, and the fifteenth transistor T15 in the dummy drive unit.

It should be noted that a circuit structure of the gate drive unit is the same as that of the dummy drive unit. The lengths of the channels of some transistors in the dummy drive unit is adjusted, and the channel widths of the transistors are correspondingly adjusted according to the adjusted length of the channel, so that the width-to-length ratios of the channels of the transistors are kept unchanged.

The first transistor T1, the second transistor T2, the third transistor T3, the fourth transistor T4, the fifth transistor T5, the sixth transistor T6, the seventh transistor T7, the eighth transistor T8, the ninth transistor T9, the tenth transistor T10, the eleventh transistor T11, the twelfth transistor T12, the thirteenth transistor T13, the fourteenth transistor T14, the fifteenth transistor T15, the sixteenth transistor T16, the seventeenth transistor T17, the eighteenth transistor T18, the nineteenth transistor T19, and the twentieth transistor T20 are all transistors of the same type, preferably P-type transistors.

On the other hand, the present application further provides a display panel including a display area and a non-display area disposed around the display area, where the non-display area is provided with the gate drive circuitry described above, the display area is provided with a plurality of pixel units, and the gate drive circuitry is electrically connected with the pixel units. It should be noted that a vertical alignment (Vertical Alignment, abbreviation: VA) type liquid crystal display has the advantages of wide viewing angle, high contrast, and the like, and the display panel in the present application is preferably a VA type display panel.

A gate drive circuitry and display panel provided by the embodiments of the present application are described in detail above, the description of the above embodiments is merely intended to help understand the core idea of the present application, and the content of the present description should not be construed as limiting the scope of the present application.

1. A gate drive circuitry comprising:
a plurality of gate drive units; and
a plurality of dummy drive units;
wherein the gate drive units are arranged in cascade with the dummy drive units, each of the gate drive units and the dummy drive units is configured to output a current-stage stage transmission signal, and each of the gate drive unit is further configured to output a current-stage scanning signal;
each of the gate drive units and the dummy drive units comprise a first pull-down maintaining module, the first pull-down maintaining module is electrically connected with a pull-up node, a first reference low level signal terminal and a current-stage stage transmission signal output terminal, and the first pull-down maintaining module is configured to control potentials of the pull-up node and the current-stage stage transmission signal output terminal; and
the first pull-down maintaining module comprises a first transistor, a gate electrode of the first transistor is electrically connected with the pull-up node, a first electrode of the first transistor is electrically connected with a first pull-down node, and a second electrode of the first transistor is electrically connected with the first reference low level signal terminal; wherein,
a length of a channel of the first transistor in the gate drive unit is lesser than a length of a channel of the first transistor in the dummy drive unit, and a width-to-length ratio of the channel of the first transistor in the gate drive unit is equal to a width-to-length ratio of the channel of the first transistor in the dummy drive unit.

2. The gate drive circuitry of claim 1, wherein each of the gate drive unit and the dummy drive unit further comprises an output module, the output module is configured to output the current-stage stage transmission signal, and the output module of the gate drive unit is further configured to output the current-stage scanning signal;
the output module comprises a second transistor, a gate electrode of the second transistor is electrically connected with the pull-up node, a first electrode of the second transistor is electrically connected with a clock signal terminal, and a second electrode of the second transistor is electrically connected with a stage transmission signal terminal; and
a length of a channel of the second transistor in the gate drive unit is lesser than a length of a channel of the second transistor in the dummy drive unit, and a width-to-length ratio of the channel of the second transistor in the gate drive unit is equal to a width-to-length ratio of the channel of the second transistor in the dummy drive unit.

3. The gate drive circuitry of claim 2, wherein the output module further comprises a third transistor and a bootstrap capacitor, a gate electrode of the third transistor is electrically connected with the pull-up node, a first electrode of the third transistor is electrically connected with the clock signal terminal, a second electrode of the third transistor is electrically connected with a current-stage scanning signal output terminal, one end of the bootstrap capacitor is electrically connected with the pull-up node, and the other end of the bootstrap capacitor is electrically connected with the current-stage scanning signal output terminal; and
a length of a channel of the third transistor in the gate drive unit is greater than a length of a channel of the third transistor in the dummy drive unit, and a width-to-length ratio of the channel of the third transistor in the gate drive unit is equal to a width-to-length ratio of the channel of the third transistor in the dummy drive unit.

4. The gate drive circuitry of claim 1, wherein the first pull-down maintaining module further comprises a fourth transistor, a fifth transistor and a sixth transistor, a gate electrode of the fourth transistor and a first electrode of the fourth transistor are electrically connected with a first control signal terminal, a second electrode of the fourth transistor is electrically connected with the first pull-down node, a gate electrode of the fifth transistor is electrically connected with the first pull-down node, a first electrode of the fifth transistor is electrically connected with the first control signal terminal, a second electrode of the fifth transistor is electrically connected with a second pull-down node, a gate electrode of the sixth transistor is electrically connected with the pull-up node, a first electrode of the sixth transistor is electrically connected with the second pull-down node, and a second electrode of the sixth transistor is electrically connected with the first reference low level signal terminal;
a length of a channel of each of at least one of the fourth transistor, the fifth transistor, or the sixth transistor in the gate drive unit is lesser than a length of a channel of a corresponding one of the fourth transistor, the fifth transistor, and the sixth transistor in the dummy drive unit; and
a width-to-length ratio of the channel of each of the fourth transistor, the fifth transistor and the sixth transistor in the gate drive unit is equal to a width-to-length ratio of the channel of each of the fourth transistor, the fifth transistor and the sixth transistor in the dummy drive unit.

5. The gate drive circuitry of claim 4, wherein the first pull-down maintaining module further comprises a seventh transistor, an eighth transistor and a ninth transistor, a gate electrode of the seventh transistor is electrically connected with the second pull-down node, a first electrode of the seventh transistor is electrically connected with a current-stage scanning signal output terminal, a second electrode of the seventh transistor is electrically connected with a second reference low level signal terminal, a gate electrode of the eighth transistor is electrically connected with the second pull-down node, a first electrode of the eighth transistor is electrically connected with the pull-up node, a second electrode of the eighth transistor is electrically connected with the first reference low level signal terminal, a gate electrode of the ninth transistor is electrically connected with the second pull-down node, a first electrode of the ninth transistor is electrically connected with the current-stage stage transmission signal output terminal, and a second electrode of the ninth transistor is electrically connected with the first reference low level signal terminal; and
a length of a channel of each of the seventh transistor and the eighth transistor in the gate drive unit is greater than a length of a channel of a corresponding one of the seventh transistor and the eighth transistor in the dummy drive unit, and a width-to-length ratio of the channel of each of the seventh transistor and the eighth transistor in the gate drive unit is equal to a width-to-length ratio of the channel of each of the seventh transistor and the eighth transistor in the dummy drive unit.

6. The gate drive circuitry of claim 5, wherein a length of a channel of the ninth transistor in the gate drive unit is greater than or equal to a length of a channel of the ninth transistor in the dummy drive unit, and a width-to-length ratio of the channel of the ninth transistor in the gate drive unit is equal to a width-to-length ratio of the channel of the ninth transistor in the dummy drive unit.

7. The gate drive circuitry of claim 1, wherein each of the gate drive unit and the dummy drive unit further comprises a second pull-down maintaining module, the second pull-down maintaining module is electrically connected with the pull-up node, the first reference low level signal terminal, and the current-stage stage transmission signal output terminal, and the second pull-down maintaining module is configured to control potentials of the pull-up node and the current-stage stage transmission signal output terminal;
the second pull-down maintaining module comprises a tenth transistor, a gate electrode of the tenth transistor is electrically connected with the pull-up node, a first electrode of the tenth transistor is electrically connected with a third pull-down node, and a second electrode of the tenth transistor is electrically connected with the first reference low level signal terminal; and
a length of a channel of the tenth transistor in the gate drive unit is lesser than a length of a channel of the tenth transistor in the dummy drive unit, and a width-to-length ratio of the channel of the tenth transistor in the gate drive unit is equal to a width-to-length ratio of the channel of the tenth transistor in the dummy drive unit.

8. The gate drive circuitry of claim 7, wherein the second pull-down maintaining module further comprises an eleventh transistor, a twelfth transistor and a thirteenth transistor, a gate electrode of the eleventh transistor and a first electrode of the eleventh transistor are electrically connected with a second control signal terminal, a second electrode of the eleventh transistor is electrically connected with the third pull-down node, a gate electrode of the twelfth transistor is electrically connected with the third pull-down node, a first electrode of the twelfth transistor is electrically connected with the second control signal terminal, a second electrode of the twelfth transistor is electrically connected with a fourth pull-down node, a gate electrode of the thirteenth transistor is electrically connected with the pull-up node, a first electrode of the thirteenth transistor is electrically connected with the fourth pull-down node, and a second electrode of the thirteenth transistor is electrically connected with the first reference low level signal terminal;
a length of a channel of each of at least one of the eleventh transistor, the twelfth transistor, or the thirteenth transistor in the gate drive unit is lesser than a length of a channel of a corresponding one of the eleventh transistor, the twelfth transistor, and the thirteenth transistor in the dummy drive unit; and
a width-to-length ratio of the channel of each of the eleventh transistor, the twelfth transistor and the thirteenth transistor in the gate drive unit is equal to a width-to-length ratio of the channel of a corresponding one of the eleventh transistor, the twelfth transistor and the thirteenth transistor in the dummy drive unit.

9. The gate drive circuitry of claim 8, wherein the second pull-down maintaining module further comprises a fourteenth transistor, a fifteenth transistor and a sixteenth transistor, a gate electrode of the fourteenth transistor is electrically connected with the fourth pull-down node, a first electrode of the fourteenth transistor is electrically connected with a current-stage scanning signal output terminal, a second electrode of the fourteenth transistor is electrically connected with a second reference low level signal terminal, a gate electrode of the fifteenth transistor is electrically connected with the fourth pull-down node, a first electrode of the fifteenth transistor is electrically connected with the pull-up node, a second electrode of the fifteenth transistor is electrically connected with the first reference low level signal terminal, a gate electrode of the sixteenth transistor is electrically connected with the fourth pull-down node, a first electrode of the sixteenth transistor is electrically connected with the current-stage stage transmission signal output terminal, and a second electrode of the sixteenth transistor is electrically connected with the first reference low level signal terminal; and
a length of a channel of each of the fourteenth transistor and the fifteenth transistor in the gate drive unit is greater than a length of a channel of a corresponding one of the fourteenth transistor and the fifteenth transistor in the dummy drive unit, and a width-to-length ratio of the channel of each of the fourteenth transistor and the fifteenth transistor in the gate drive unit is equal to a width-to-length ratio of the channel of a corresponding one of the fourteenth transistor and the fifteenth transistor in the dummy drive unit.

10. The gate drive circuitry of claim 9, wherein a length of a channel of the sixteenth transistor in the gate drive unit is greater than or equal to a length of a channel of the sixteenth transistor in the dummy drive unit, and a width-to-length ratio of the channel of the sixteenth transistor in the gate drive unit is equal to a width-to-length ratio of the channel of the sixteenth transistor in the dummy drive unit.

11. A display panel comprising a display area and a non-display area disposed around the display area, wherein the non-display area is provided with a gate drive circuitry, the gate drive circuitry comprises:
a plurality of gate drive units; and
a plurality of dummy drive units;
wherein the gate drive units are arranged in cascade with the dummy drive units, each of the gate drive units and the dummy drive units is configured to output a current-stage stage transmission signal, and each of the gate drive unit is further configured to output a current-stage scanning signal;
each of the gate drive units and the dummy drive units comprise a first pull-down maintaining module, the first pull-down maintaining module is electrically connected with a pull-up node, a first reference low level signal terminal and a current-stage stage transmission signal output terminal, and the first pull-down maintaining module is configured to control potentials of the pull-up node and the current-stage stage transmission signal output terminal; and
the first pull-down maintaining module comprises a first transistor, a gate electrode of the first transistor is electrically connected with the pull-up node, a first electrode of the first transistor is electrically connected with a first pull-down node, and a second electrode of the first transistor is electrically connected with the first reference low level signal terminal; wherein,
a length of a channel of the first transistor in the gate drive unit is lesser than a length of a channel of the first transistor in the dummy drive unit, and a width-to-length ratio of the channel of the first transistor in the gate drive unit is equal to a width-to-length ratio of the channel of the first transistor in the dummy drive unit.

12. The display panel of claim 11, wherein each of the gate drive unit and the dummy drive unit further comprises an output module, the output module is configured to output the current-stage stage transmission signal, and the output module of the gate drive unit is further configured to output the current-stage scanning signal;
the output module comprises a second transistor, a gate electrode of the second transistor is electrically connected with the pull-up node, a first electrode of the second transistor is electrically connected with a clock signal terminal, and a second electrode of the second transistor is electrically connected with a stage transmission signal terminal; and
a length of a channel of the second transistor in the gate drive unit is lesser than a length of a channel of the second transistor in the dummy drive unit, and a width-to-length ratio of the channel of the second transistor in the gate drive unit is equal to a width-to-length ratio of the channel of the second transistor in the dummy drive unit.

13. The display panel of claim 12, wherein the output module further comprises a third transistor and a bootstrap capacitor, a gate electrode of the third transistor is electrically connected with the pull-up node, a first electrode of the third transistor is electrically connected with the clock signal terminal, a second electrode of the third transistor is electrically connected with a current-stage scanning signal output terminal, one end of the bootstrap capacitor is electrically connected with the pull-up node, and the other end of the bootstrap capacitor is electrically connected with the current-stage scanning signal output terminal; and
a length of a channel of the third transistor in the gate drive unit is greater than a length of a channel of the third transistor in the dummy drive unit, and a width-to-length ratio of the channel of the third transistor in the gate drive unit is equal to a width-to-length ratio of the channel of the third transistor in the dummy drive unit.

14. The display panel of claim 11, wherein the first pull-down maintaining module further comprises a fourth transistor, a fifth transistor and a sixth transistor, a gate electrode of the fourth transistor and a first electrode of the fourth transistor are electrically connected with a first control signal terminal, a second electrode of the fourth transistor is electrically connected with the first pull-down node, a gate electrode of the fifth transistor is electrically connected with the first pull-down node, a first electrode of the fifth transistor is electrically connected with the first control signal terminal, a second electrode of the fifth transistor is electrically connected with a second pull-down node, a gate electrode of the sixth transistor is electrically connected with the pull-up node, a first electrode of the sixth transistor is electrically connected with the second pull-down node, and a second electrode of the sixth transistor is electrically connected with the first reference low level signal terminal;
a length of a channel of each of at least one of the fourth transistor, the fifth transistor, or the sixth transistor in the gate drive unit is lesser than a length of a channel of a corresponding one of the fourth transistor, the fifth transistor, and the sixth transistor in the dummy drive unit; and
a width-to-length ratio of the channel of each of the fourth transistor, the fifth transistor and the sixth transistor in the gate drive unit is equal to a width-to-length ratio of the channel of each of the fourth transistor, the fifth transistor and the sixth transistor in the dummy drive unit.

15. The display panel of claim 14, wherein the first pull-down maintaining module further comprises a seventh transistor, an eighth transistor and a ninth transistor, a gate electrode of the seventh transistor is electrically connected with the second pull-down node, a first electrode of the seventh transistor is electrically connected with a current-stage scanning signal output terminal, a second electrode of the seventh transistor is electrically connected with a second reference low level signal terminal, a gate electrode of the eighth transistor is electrically connected with the second pull-down node, a first electrode of the eighth transistor is electrically connected with the pull-up node, a second electrode of the eighth transistor is electrically connected with the first reference low level signal terminal, a gate electrode of the ninth transistor is electrically connected with the second pull-down node, a first electrode of the ninth transistor is electrically connected with the current-stage stage transmission signal output terminal, and a second electrode of the ninth transistor is electrically connected with the first reference low level signal terminal; and
a length of a channel of each of the seventh transistor and the eighth transistor in the gate drive unit is greater than a length of a channel of a corresponding one of the seventh transistor and the eighth transistor in the dummy drive unit, and a width-to-length ratio of the channel of each of the seventh transistor and the eighth transistor in the gate drive unit is equal to a width-to-length ratio of the channel of each of the seventh transistor and the eighth transistor in the dummy drive unit.

16. The display panel of claim 15, wherein a length of a channel of the ninth transistor in the gate drive unit is greater than or equal to a length of a channel of the ninth transistor in the dummy drive unit, and a width-to-length ratio of the channel of the ninth transistor in the gate drive unit is equal to a width-to-length ratio of the channel of the ninth transistor in the dummy drive unit.

17. The display panel of claim 11, wherein each of the gate drive unit and the dummy drive unit further comprises a second pull-down maintaining module, the second pull-down maintaining module is electrically connected with the pull-up node, the first reference low level signal terminal, and the current-stage stage transmission signal output terminal, and the second pull-down maintaining module is configured to control potentials of the pull-up node and the current-stage stage transmission signal output terminal;
the second pull-down maintaining module comprises a tenth transistor, a gate electrode of the tenth transistor is electrically connected with the pull-up node, a first electrode of the tenth transistor is electrically connected with a third pull-down node, and a second electrode of the tenth transistor is electrically connected with the first reference low level signal terminal; and
a length of a channel of the tenth transistor in the gate drive unit is lesser than a length of a channel of the tenth transistor in the dummy drive unit, and a width-to-length ratio of the channel of the tenth transistor in the gate drive unit is equal to a width-to-length ratio of the channel of the tenth transistor in the dummy drive unit.

18. The display panel of claim 17, wherein the second pull-down maintaining module further comprises an eleventh transistor, a twelfth transistor and a thirteenth transistor, a gate electrode of the eleventh transistor and a first electrode of the eleventh transistor are electrically connected with a second control signal terminal, a second electrode of the eleventh transistor is electrically connected with the third pull-down node, a gate electrode of the twelfth transistor is electrically connected with the third pull-down node, a first electrode of the twelfth transistor is electrically connected with the second control signal terminal, a second electrode of the twelfth transistor is electrically connected with a fourth pull-down node, a gate electrode of the thirteenth transistor is electrically connected with the pull-up node, a first electrode of the thirteenth transistor is electrically connected with the fourth pull-down node, and a second electrode of the thirteenth transistor is electrically connected with the first reference low level signal terminal;
a length of a channel of each of at least one of the eleventh transistor, the twelfth transistor, or the thirteenth transistor in the gate drive unit is lesser than a length of a channel of a corresponding one of the eleventh transistor, the twelfth transistor, and the thirteenth transistor in the dummy drive unit; and
a width-to-length ratio of the channel of each of the eleventh transistor, the twelfth transistor and the thirteenth transistor in the gate drive unit is equal to a width-to-length ratio of the channel of a corresponding one of the eleventh transistor, the twelfth transistor and the thirteenth transistor in the dummy drive unit.

19. The display panel of claim 18, wherein the second pull-down maintaining module further comprises a fourteenth transistor, a fifteenth transistor and a sixteenth transistor, a gate electrode of the fourteenth transistor is electrically connected with the fourth pull-down node, a first electrode of the fourteenth transistor is electrically connected with a current-stage scanning signal output terminal, a second electrode of the fourteenth transistor is electrically connected with a second reference low level signal terminal, a gate electrode of the fifteenth transistor is electrically connected with the fourth pull-down node, a first electrode of the fifteenth transistor is electrically connected with the pull-up node, a second electrode of the fifteenth transistor is electrically connected with the first reference low level signal terminal, a gate electrode of the sixteenth transistor is electrically connected with the fourth pull-down node, a first electrode of the sixteenth transistor is electrically connected with the current-stage stage transmission signal output terminal, and a second electrode of the sixteenth transistor is electrically connected with the first reference low level signal terminal; and
a length of a channel of each of the fourteenth transistor and the fifteenth transistor in the gate drive unit is greater than a length of a channel of a corresponding one of the fourteenth transistor and the fifteenth transistor in the dummy drive unit, and a width-to-length ratio of the channel of each of the fourteenth transistor and the fifteenth transistor in the gate drive unit is equal to a width-to-length ratio of the channel of a corresponding one of the fourteenth transistor and the fifteenth transistor in the dummy drive unit.

20. The display panel of claim 19, wherein a length of a channel of the sixteenth transistor in the gate drive unit is greater than or equal to a length of a channel of the sixteenth transistor in the dummy drive unit, and a width-to-length ratio of the channel of the sixteenth transistor in the gate drive unit is equal to a width-to-length ratio of the channel of the sixteenth transistor in the dummy drive unit.
